(19) United States
(12) Patent Application Publication
(10) Pub. No.: US 2026/0316862 A1
(43) Pub. Date: Oct. 15, 2026

(54) Hybrid Walk-Drive Robotic Platform with Central Structural Apparatus Interface

(71) Applicant: MUHAMMAD JASEEM, HOUSTON, TX (US)

(72) Inventor: MUHAMMAD JASEEM, HOUSTON, TX (US)

(21) Appl. No.: 19/458,876

(22) Filed: Jan. 25, 2026

(51) Int. Cl. B62D 57/028; B25J 9/12; B25J 9/16; B25J 11/00

(52) U.S. Cl. CPC B62D 57/028; B25J 9/123; B25J 9/1664; B25J 11/0075; B25J 11/0085

(57) ABSTRACT

A mobile robotic platform includes a body supported by a plurality of legs, each leg having a passive wheel with a selectively actuated locking mechanism. Two powered drive wheels are mounted to the body and are selectively deployed by multiple linear actuators to engage a ground surface. A controller selectively transitions the robotic platform between a walking mode and a driving mode by coordinating deployment of the powered drive wheels and locking or unlocking of the passive wheels. The body further includes a central structural aperture configured to mechanically support interchangeable apparatuses and provide electrical and data connectivity.

The interchangeable apparatuses may include cleaning devices, projection-based interaction devices, and non-lethal fluid or marking devices. The robotic platform is adaptable for operation across residential, commercial, industrial, and outdoor environments.

### CROSS-REFERENCE TO RELATED APPLICATIONS

This application claims no priority to any prior United States or foreign patent application.

### FIELD OF THE INVENTION

The present invention relates to mobile robotic systems, and more particularly to a reconfigurable robotic platform capable of selectively operating in a walking mode or a wheeled driving mode and supporting interchangeable apparatuses.

### BACKGROUND OF THE INVENTION

Legged robotic platforms typically require multiple drive motors within each leg, increasing mechanical complexity, cost, and power consumption. Wheeled robotic platforms are generally more efficient but are limited in their ability to traverse uneven terrain. Hybrid systems often permanently integrate motors into the legs or wheels, resulting in increased complexity, increased weight, and higher manufacturing costs.

Accordingly, there exists a need for a robotic platform capable of selectively transitioning between walking and driving modes without requiring drive motors within the legs, while also supporting interchangeable apparatuses for multiple applications.

### SUMMARY OF THE INVENTION

The invention provides a mobile robotic platform comprising a body supported by a plurality of legs, each leg including a passive wheel having a selectively actuated locking mechanism. Two powered drive wheels are mounted to the body and are deployable by a plurality of linear actuators.

A controller coordinates transitions between a walking mode and a driving mode by selectively deploying the powered drive wheels and actuating the locking mechanisms associated with the passive wheels.

The body further includes a central structural aperture configured to mechanically support interchangeable apparatuses and provide electrical and data connectivity. The interchangeable apparatuses may include cleaning devices, projection-based interaction devices, inspection devices, signaling devices, and non-lethal fluid or marking devices.

The robotic platform is adaptable for operation across residential, commercial, industrial, and outdoor environments.

### BRIEF DESCRIPTION OF THE DRAWINGS

FIG. 1 is a perspective view of the robotic platform without an apparatus installed.

FIG. 2 is a rear view illustrating powered drive wheels and linear actuators.

FIG. 3 is a perspective view showing the robotic platform in a driving mode.

FIG. 4 is a top view with the cover removed.

FIG. 5 is a perspective view of a projector apparatus.

FIG. 6 is a perspective view showing multiple apparatuses mounted simultaneously.

FIG. 7 is a rear view of a vacuum apparatus.

FIG. 8 is a side view showing floor-level cleaning.

FIG. 9 is a perspective view of a rotational fluid and marking apparatus.

### DETAILED DESCRIPTION OF THE INVENTION

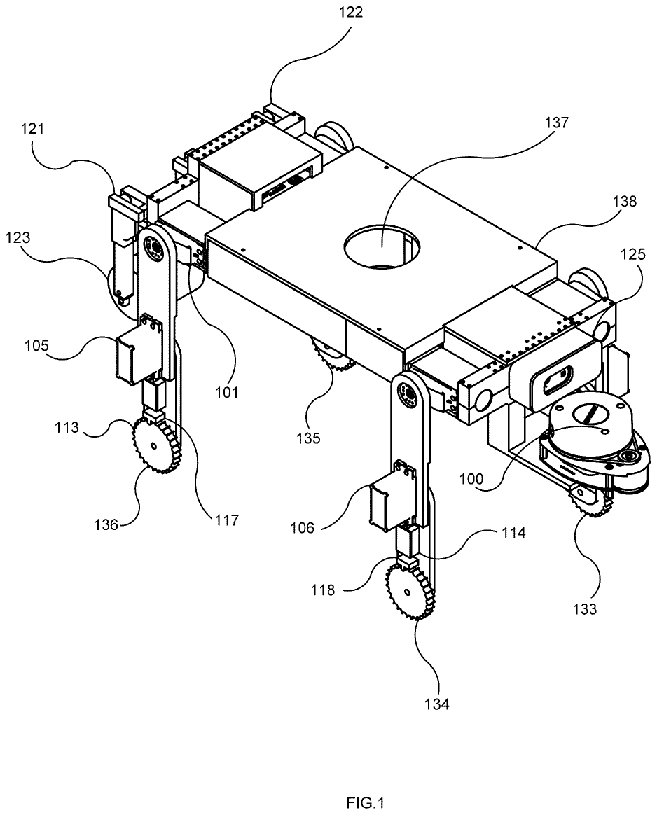

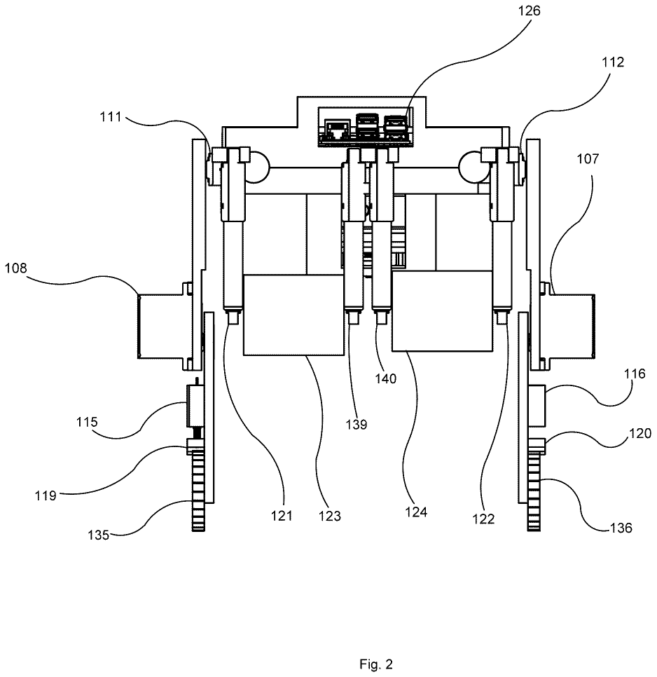

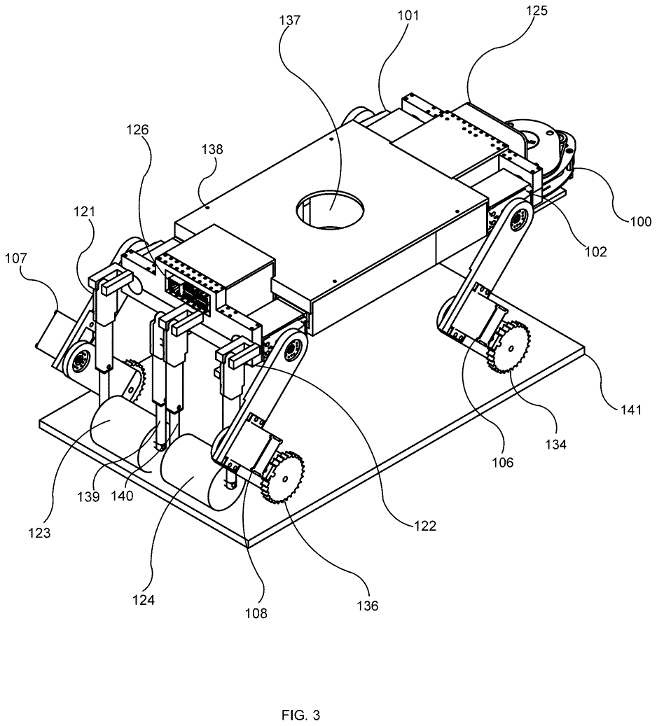

Referring to FIGS. 1-3, the robotic platform includes a body supported by a plurality of legs. Each leg includes a passive wheel having a selectively actuated locking mechanism. No drive motors are located within the legs. Propulsion is provided exclusively by two powered drive wheels mounted to the body.

The powered drive wheels are deployable by a plurality of linear actuators. In one embodiment, four linear actuators cooperatively deploy the powered drive wheels to engage a ground surface. When deployed, the powered drive wheels elevate or partially unload the passive wheels to enable efficient wheeled motion.

The locking mechanisms associated with the passive wheels are actuated by motorized actuators configured to selectively lock or unlock rotation of the passive wheels. During walking mode, the powered drive wheels are retracted and the passive wheels are unlocked. During driving mode, the powered drive wheels are deployed and the passive wheels are locked.

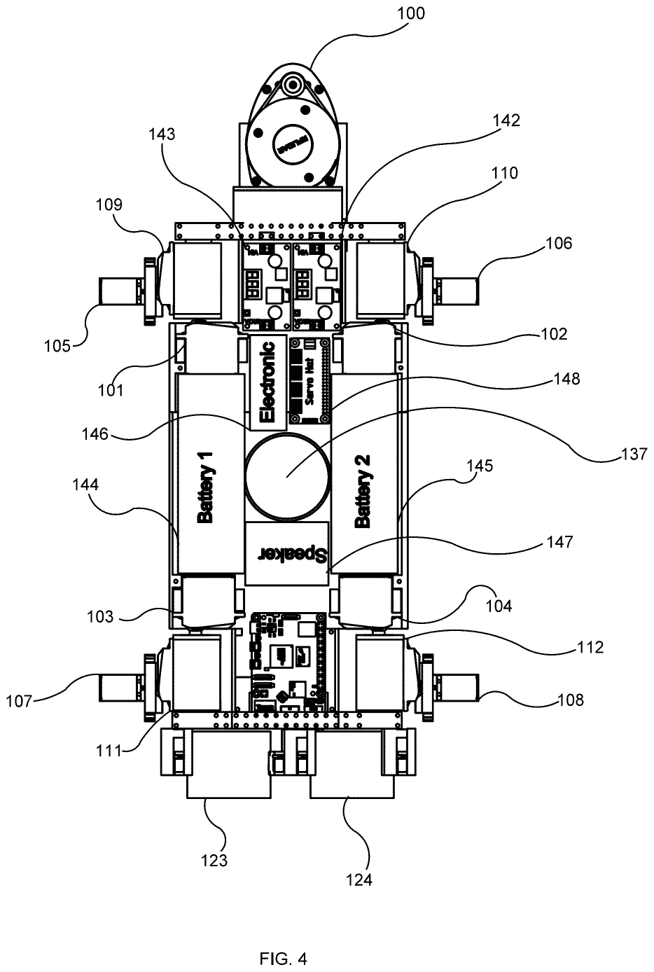

Referring to FIG. 4, a central structural aperture extends through the body and provides a load-bearing interface for interchangeable apparatuses. The central structural aperture further includes electrical and data connections configured to provide power and communication to mounted apparatuses.

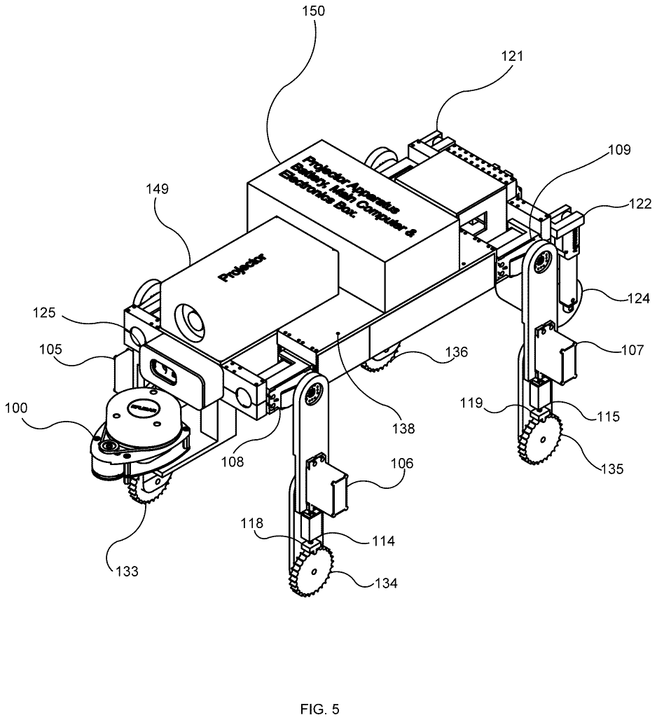

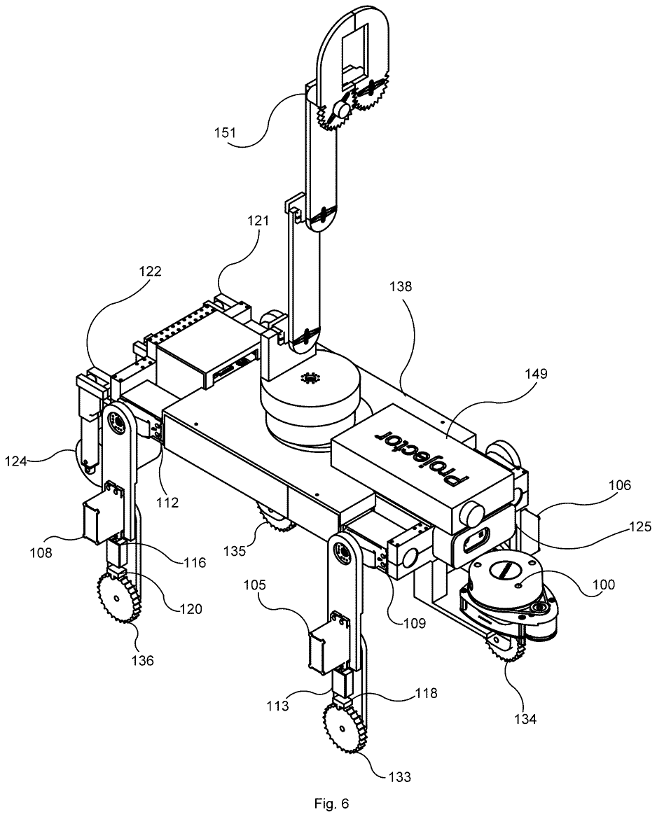

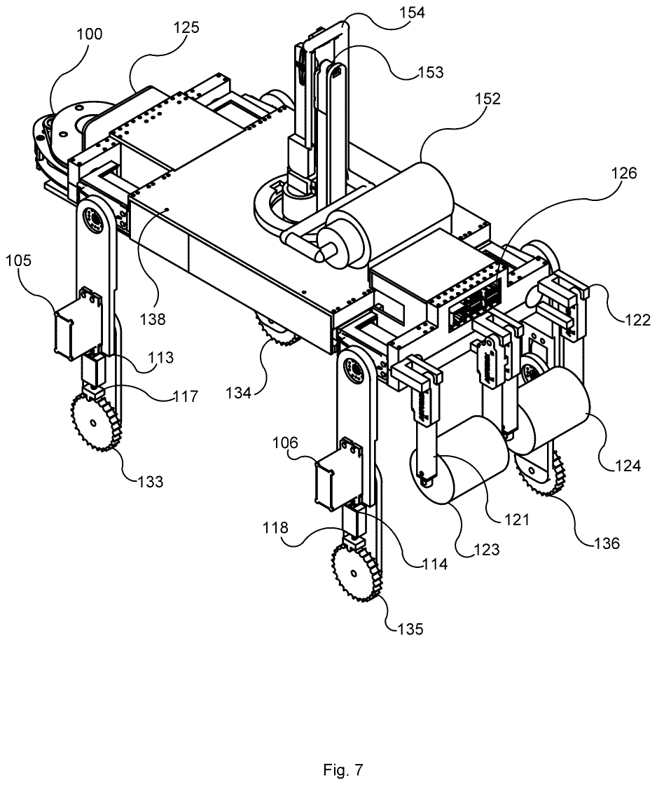

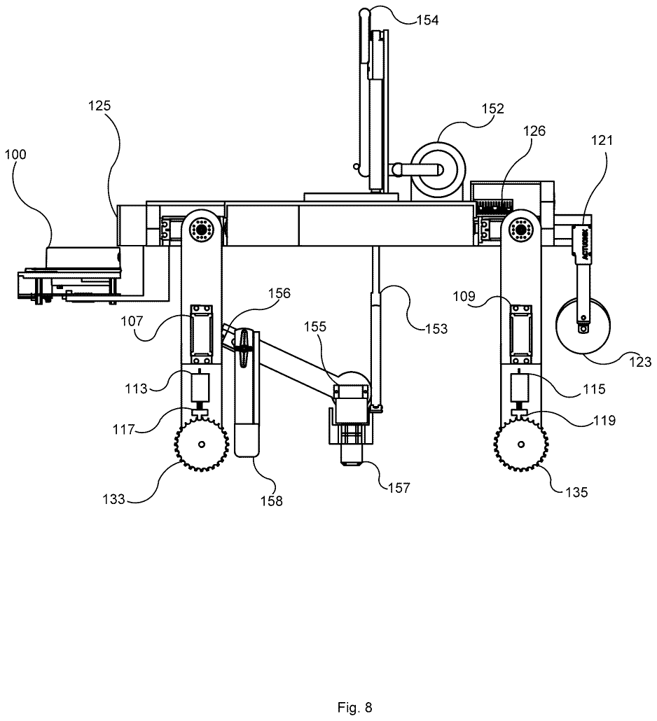

Referring to FIGS. 5-8, interchangeable apparatuses may include projector-based educational or signaling devices, vacuum cleaning devices operable above and below the body, inspection devices, or maintenance tools. The vacuum cleaning apparatus may include a linear actuator configured to move a cleaning head between elevated and floor-level positions.

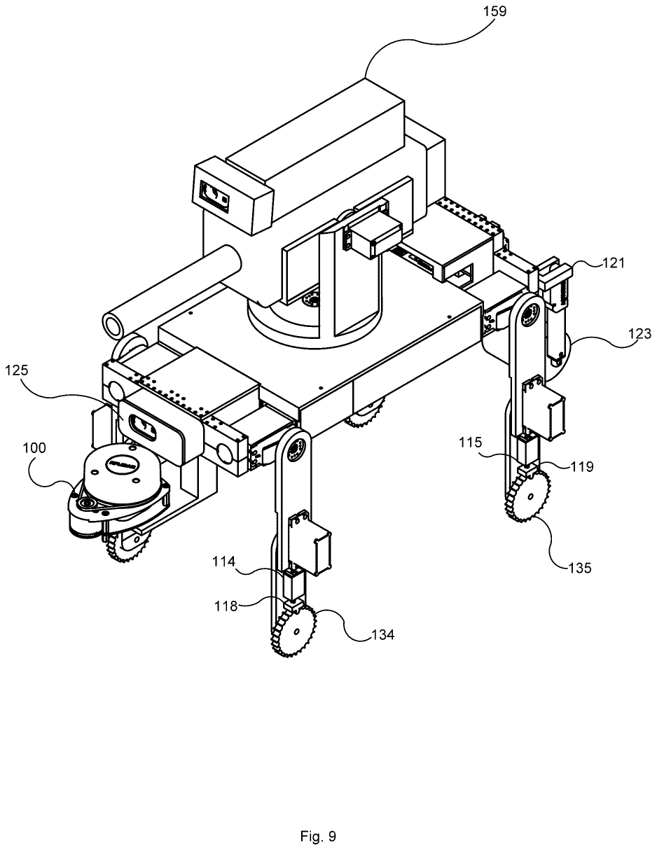

Referring to FIG. 9, a rotational fluid and marking apparatus may deliver water or marking projectiles for non-lethal property protection or signaling applications.

The controller is configured to automatically coordinate deployment of the powered drive wheels and locking of the passive wheels in response to detected operating conditions. The detected operating conditions may include indoor or outdoor environments, ground surface type, obstacle detection, or human presence.

The controller may operate the robotic platform in autonomous patrol, inspection, cleaning, maintenance, or interaction modes.

1. A mobile robotic platform comprising:
a body;
a plurality of legs coupled to the body, each leg including a passive wheel;
a locking mechanism associated with each passive wheel and actuated by a motorized actuator;
two powered drive wheels mounted to the body;
a plurality of linear actuators configured to deploy the powered drive wheels; and
a controller configured to switch the robotic platform between a walking mode and a driving mode.

2. The mobile robotic platform of claim 1, wherein the plurality of linear actuators comprises four linear actuators arranged to cooperatively deploy the powered drive wheels.

3. The mobile robotic platform of claim 1, wherein no drive motors are located within the legs.

4. The mobile robotic platform of claim 1, further comprising a central structural aperture extending through the body and configured to receive an interchangeable apparatus.

5. The mobile robotic platform of claim 4, wherein the central structural aperture provides a mechanical load-bearing interface and an electrical and data interface.

6. The mobile robotic platform of claim 4, wherein the interchangeable apparatus comprises a vacuum cleaning apparatus operable above and below the body.

7. The mobile robotic platform of claim 6, wherein the vacuum cleaning apparatus includes a linear actuator configured to move a cleaning head between elevated and floor-level positions.

8. The mobile robotic platform of claim 4, wherein multiple interchangeable apparatuses are simultaneously mounted to the body.

9. The mobile robotic platform of claim 4, wherein the interchangeable apparatus comprises a rotational fluid and marking apparatus configured to deliver water and marking projectiles.

10. The mobile robotic platform of claim 1, wherein the controller is configured to automatically coordinate deployment of the powered drive wheels and locking of the passive wheels in response to detected operating conditions.

11. The mobile robotic platform of claim 10, wherein the detected operating condition comprises an indoor or outdoor environment.

12. The mobile robotic platform of claim 10, wherein the detected operating condition comprises a ground surface type.

13. The mobile robotic platform of claim 10, wherein the controller is configured to operate the robotic platform in an autonomous patrol or inspection mode.

14. The mobile robotic platform of claim 13, wherein the interchangeable apparatus comprises an industrial or service apparatus configured to perform cleaning, spraying, marking, inspection, signaling, or maintenance.

15. The mobile robotic platform of claim 10, wherein the controller is configured to modify operation of the robotic platform in response to detection of human presence.
